(19) United States
(12) Patent Application Publication
(10) Pub. No.: US 2024/0253787 A1
(43) Pub. Date: Aug. 1, 2024

(54) LOUNGE SYSTEM FOR AN INTERNAL CABIN OF AN AIRCRAFT

(71) Applicant: THE BOEING COMPANY, Arlington, VA (US)

(72) Inventors: Cynthia Vandewall, Snohomish, WA (US); Jared Bowen, Lynnwood, WA (US); Alejandro Lozano Robledo, Cincinnati, OH (US); Juan Sebastian Ramirez Loaiza, Cincinnati, OH (US); Rebecah Pelle, Melbourne, KY (US); Zichun Gao, Cincinnati, OH (US); Yifei Wu, Cincinnati, OH (US)

(73) Assignee: THE BOEING COMPANY, Arlington, VA (US)

(21) Appl. No.: 18/161,183

(22) Filed: Jan. 30, 2023

(51) Int. Cl. B64D 11/06; B64D 11/00

(52) U.S. Cl. CPC B64D 11/0602; B64D 11/0015; B64D 11/0023

(57) ABSTRACT

A lounge system for an internal cabin of an aircraft includes a housing including one or more walls defining an internal compartment. One or more passenger supports are moveably coupled to the one or more walls. The one or more passenger supports are movable between a stowed position and a deployed position. The lounge system can also include one or more partition walls moveably coupled to the one or more walls. The one or more partition walls are moveable between an extended position that divides the internal compartment into sub-compartments, and a stowed position. The lounge system can also include one or more audio-visual (AV) devices secured to one or both of the one or more walls or the one or more partition walls.

### FIELD OF THE DISCLOSURE

Examples of the present disclosure generally relate to a lounge system for an internal cabin of an aircraft.

### BACKGROUND OF THE DISCLOSURE

Aircraft are used to transport passengers and cargo between various locations. Air travel can cause anxiety for certain individuals. Further, the limited space within an internal cabin restricts certain types of activities and privacy therein. Often, a galley or a lavatory within an internal cabin may be the only area for individuals (whether passengers or crew members) to have a private break during a flight.

### SUMMARY OF THE DISCLOSURE

A need exists for areas within an internal cabin of an aircraft for individuals to relax, stretch their legs, have a moment of privacy, meet with group members, and the like. Further, a need exists for areas within an internal cabin of an aircraft where individuals can enjoy a calm, private setting away from a seating area.

With those needs in mind, certain examples of the present disclosure provide a lounge system for an internal cabin of an aircraft. The lounge system includes a housing including one or more walls defining an internal compartment, and one or more passenger supports moveably coupled to the one or more walls. The one or more passenger supports are movable between a stowed position and a deployed position.

In at least one example, the lounge system also includes one or more actuators operatively coupled to the one or more passenger supports. The one or more actuators are configured to automatically move the one or more passenger supports between the stowed position and the deployed position.

In at least one example, the one or more passenger supports include one or more of a chair, a bench, a bed, a tray, or a desk.

In at least one example, the lounge system also includes one or more partition walls moveably coupled to the one or more walls. The one or more partition walls are moveable between an extended position that divides the internal compartment into sub-compartments, and a stowed position.

In at least one example, the lounge system also includes one or more audio-visual (AV) devices secured to one or both of the one or more walls or the one or more partition walls. The one or more AV devices can include a projector configured to project content onto one or both of: (a) the one or more partition walls in the extended position, or (b) the one or more walls. The one or more AV devices can include a television mounted on the one or more walls. The AV devices can include various other types of audio and visual equipment.

In at least one example, the one or more passenger supports are also moveably coupled to the one or more partition walls.

In at least one example, one or more actuators are operatively coupled to the one or more partition walls. The one or more actuators are configured to automatically move the one or more partition walls between the extended position and the stowed position.

In at least one example, the housing is configured to be removably secured within the internal cabin. In at least one example, the housing is configured to be secured to one or more seat tracks of a floor within the internal cabin.

The housing is configured to be disposed outside of a passenger seating area of the internal cabin. In at least one example, the housing is configured to be disposed within an aft area of the internal cabin.

Certain examples of the present disclosure provide an aircraft including an internal cabin, and a lounge system within the internal cabin, as described herein.

Certain examples of the present disclosure provide a method including disposing a lounge system with an internal cabin of an aircraft, as described herein.

### BRIEF DESCRIPTION OF THE DRAWINGS

FIG. 1 illustrates a block diagram of a lounge system within an internal cabin of an aircraft, according to an example of the present disclosure.

FIG. 2 illustrates a perspective front view of an aircraft, according to an example of the present disclosure.

FIG. 3A illustrates a top plan view of an internal cabin of an aircraft, according to an example of the present disclosure.

FIG. 3B illustrates a top plan view of an internal cabin of an aircraft, according to an example of the present disclosure.

FIG. 4 illustrates a side view of a passenger seat, according to an example of the present disclosure.

FIG. 5 illustrates a perspective front view of a lounge system, according to an example of the present disclosure.

FIG. 6 illustrates a perspective front view of a lounge system, according to an example of the present disclosure.

FIG. 7 illustrates a perspective front view of a lounge system, according to an example of the present disclosure.

FIG. 8 illustrates a perspective front view of a lounge system, according to an example of the present disclosure.

FIG. 9 illustrates a perspective internal view of an internal cabin of an aircraft, according to an example of the present disclosure.

FIG. 10 illustrates a perspective internal view of a lounge system, according to an example of the present disclosure.

FIG. 11 illustrates a perspective internal view of a lounge system, according to an example of the present disclosure.

FIG. 12 illustrates a perspective internal view of a lounge system, according to an example of the present disclosure.

FIG. 13 illustrates a perspective internal view of a lounge system, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

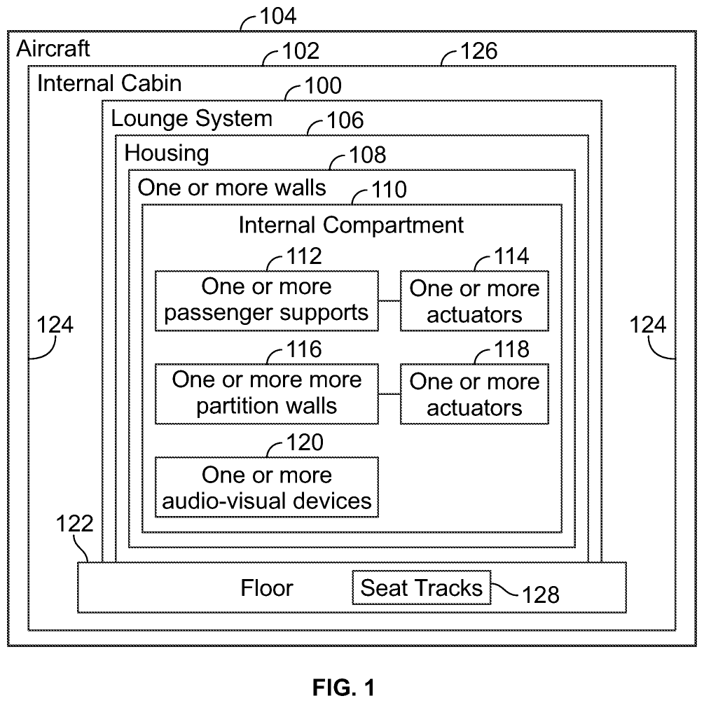

FIG. 1 illustrates a block diagram of a lounge system 100 within an internal cabin 102 of an aircraft 104, according to an example of the present disclosure. The lounge system 100 includes a housing 106 having one or more walls 108 that define an internal compartment 110. In at least one example, the housing 106 can be inserted into the internal cabin 102, and removed, if desired. As such, the housing 106 can be removably secured within the internal cabin 102. As another example, portions of the internal cabin 102 of the aircraft 104 form the housing 106.

The internal compartment 110 includes one or more passenger supports 112. Examples of the passenger supports 112 include chairs, benches, beds, desks, and/or the like. In at least one example, the passenger support(s) 112 are secured to the one or more walls 108. For example, the passenger support(s) 112 can extend from the wall(s) 108. As a further example, the passenger support(s) 112 can be moveably secured to the wall(s) 108. As an example, the passenger support(s) 112 can be configured to be moved between a stowed position and a deployed position in relation to the wall(s) 108. As a further example, the passenger support(s) 112 can be configured to be folded into the stowed position, and unfolded into the deployed position. As another example, the passenger support(s) 112 can be configured to be pivoted between the stowed position and the deployed position. As another example, the passenger support(s) 112 are configured to be slidably adjusted between the stowed position and the deployed position. In the stowed position, the passenger support(s) 112 can rest against the wall(s) 108. Optionally, the wall(s) 108 can include internal chambers that receive and retain the passenger support(s) 112 in the stowed position.

The passenger support(s) 112 can be manually moved between the stowed position and the deployed position. As another example, the passenger support(s) 112 can be automatically moved between the stowed position and the deployed position. For example, one or more actuators 114 (such as motors) can be operatively coupled to the one or more passenger supports 112, and configured to automatically move the passenger support(s) 112 between the stowed position and the deployed position. Optionally, the lounge system 100 may not include an actuator.

In at least one example, the internal compartment 110 also includes one or more partition walls 116, which can be coupled to the one or more walls 108. The partition wall(s) 116 can be permanently fixed in position, and divide the internal compartment 110 into sub-compartments or pods. As another example, the partition wall(s) 116 can be moveably coupled to the partition wall(s) 116. For example, the partition wall(s) 116 can be configured to be moved between an extended position that divides the internal compartment 110 into sub-compartments, and a retracted position in which the partition wall(s) 116 do not divide the internal compartment 110 into sub-compartments. For example, the partition wall(s) 116 can be formed of a flexible plastic that is configured to be wound around a roller, which can be secured to a wall 108, such as a ceiling or sidewall. An individual can manually unroll and roll the partition wall(s) 116 between the extended position and the retracted position. As another example, the partition wall(s) 116 can include folded segments that allow the partition wall(s) 116 to be moved between an unfolded position (for example, an extended position), and a folded position (for example, a retracted position). As another example, the partition wall(s) 116 can be configured to be slidably adjusted between the extended position and the retracted position. In at least one example, the partition wall(s) 116 can be a sliding door at a front end, rear end, or extending along a length within the lounge system 100. In at least one example one or more actuators 118 (such as motors) are operatively coupled to the partition walls 116, and configured to automatically move the partition wall(s) 116 between the extended position and the retracted position. Optionally, the lounge system 100 may not include an actuator. Also, optionally, the lounge system 100 may not include a partition wall.

In at least one example, the lounge system 100 includes one or more audio-visual (AV) devices 120, which can be secured to the one or more walls 108. Examples of the AV devices 120 include projectors that are configured to project graphics, images, and/or videos on the one or more walls 108, and/or the one or more partition walls 116, a television screen, a video game system, speakers, and/or the like. Optionally, the lounge system 100 may not include an AV device.

As noted, the lounge system 100 can be configured to be secured within the internal cabin 102. For example, the housing 106 can be secured between a floor 122, sidewalls 124, and a ceiling 126 of the internal cabin 102 within a fuselage of the aircraft 104. That is, in at least one example, the lounge system 100 is a separate monument or component that is installed within the internal cabin 102. In at least one example, the housing 106 is secured to one or more seat tracks 128 within the floor 122. The lounge system 100 can be selectively installed within and removed from the internal cabin 102. In at least one other example, the floor 122, the sidewalls 124, and the ceiling of the internal cabin 102 form the internal compartment 110 of the lounge system 100.

In at least one example, the lounge system 100 can be disposed within an aft area of the internal cabin 102. Passengers can reserve space within the lounge space 100 prior to (or during) a flight of the aircraft 104, thereby providing another source of revenue for an airline.

The lounge system 100 provides one or more activity pods for private and/or multi-activity use within the internal cabin 102. The internal compartment 110 can be individually customized based on desires and/or needs of passengers. The lounge system 100 allows for individuals (such as passengers or crew members) to perform productive activities (such as employment-related activities), relax, or be entertained during a flight of the aircraft 104.

In at least one example, the lounge system 100 does not include passenger seats that support passengers during take-off and landing phases of a flight. For example, individuals are assigned separate and distinct passengers seats within the internal cabin 102. The passenger seats are not within the lounge system 100.

In at least one example, the lounge system 100 can replace different rows of passenger seats within the internal cabin 102. For example, three rows of seats proximate to an aft area within the internal cabin 102 can be removed to provide space for installation of the lounge system 100. As a further example, various items can be stored within the lounge system 100 when not being used by individuals. For example, the lounge system 100 can optionally or additionally used to stow passenger and/or crew member baggage, cargo items, and/or the like.

In at least one example, the lounge system 100 can be selectively configured between different configurations. Passengers can reserve an entirety of the lounge system 100 as a single pod. As another example, one or more partition walls 116 can be moved into extended position to divide the internal compartment 110 into sub-compartments, each of which can provide a distinct pod that can be reserved by different passengers.

In at least one example, the passenger support(s) 112 provide reconfigurable seats having modular components and can allow multiple types that allow individuals to sit down and face forward, unfold into a bench or bed that allow individuals to lay down, stand up and stretch (for example, the passenger support(s) 112 can be moved into a stowed position), and/or the like.

In at least one example, the AV devices 120 can be used to provide one or more interactive screens. The partition wall(s) 116 can be semi-rigid, and provide a display screen for an AV device 120 in the form of a projector. As another example, the AV device 120 can be a virtual reality system (such as a gaming or video system) that allows the internal compartment 110 and/or a sub-compartment formed by at least one partition wall 116 in an extended position to become a virtual or augmented reality space, and can be in communication with locations and/or individuals not within the aircraft.

In at least one example, the housing 106, such as the one or more walls 108, and/or the partition wall(s) 116 can be formed of a noise-canceling or a noise-absorbing material. As such, noise generated within the internal compartment 110 can be less susceptible from escaping into other portions of the internal cabin 102 and/or other closed portions of the lounge system 100.

The internal compartment 110 can be used by families traveling with children, such as to calm down crying babies, and/or to entertain the children during long flights. As another example, business travelers can conduct meetings and/or other business within the internal compartment 110. As another example, passengers can use the internal compartment to stretch, exercise, and/or the like during a flight. As another example, passengers who prefer to complete a pre-immigration check-in (and can be in communication with agents who are remote from the aircraft) in a more private setting can utilize the internal compartment. The lounge system 100 is potentially especially useful during long-haul flights, such as intercontinental and/or international flights.

As described herein, the lounge system 100 for the internal cabin 102 of the aircraft 104 includes the housing 106 including the one or more walls 108 defining the internal compartment 110. One or more passenger supports 112 are moveably coupled to the one or more walls 108. The one or more passenger supports 112 are movable between a stowed position and a deployed position. In at least one example, the lounge system 100 also includes the one or more partition walls 116 moveably coupled to the one or more walls 108. The one or more partition walls 116 are moveable between an extended position that divides the internal compartment 110 into sub-compartments, and a stowed position. In at least one example, the lounge system 100 also includes the one or more audio-visual (AV) devices 120 secured to one or both of the one or more walls 108 or the one or more partition walls 116.

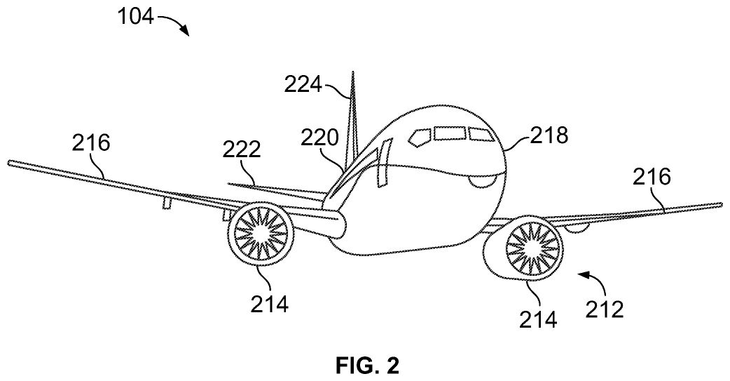

FIG. 2 illustrates a perspective front view of an aircraft 104, according to an example of the present disclosure. The aircraft 104 includes a propulsion system 212 that includes engines 214, for example. Optionally, the propulsion system 212 may include more engines 214 than shown. The engines 214 are carried by wings 216 of the aircraft 104. In other examples, the engines 214 may be carried by a fuselage 218 and/or an empennage 220. The empennage 220 may also support horizontal stabilizers 222 and a vertical stabilizer 224. The fuselage 218 of the aircraft 104 defines an internal cabin, which includes a flight deck or cockpit, one or more work sections (for example, galleys, personnel carry-on baggage areas, and the like), one or more passenger sections (for example, first class, business class, and coach sections), one or more lavatories, and/or the like. FIG. 2 shows an example of an aircraft 104. It is to be understood that the aircraft 104 can be sized, shaped, and configured differently than shown in FIG. 2.

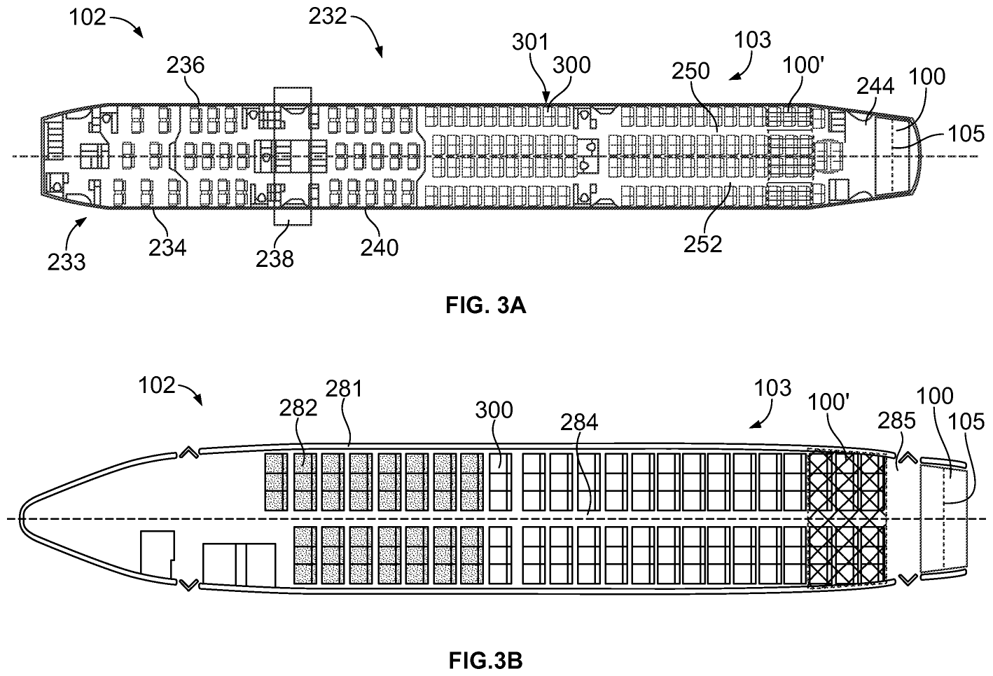

FIG. 3A illustrates a top plan view of an internal cabin 102 of an aircraft, according to an example of the present disclosure. The internal cabin 102 may be within a fuselage 232 of the aircraft. For example, one or more fuselage walls may define an interior of the internal cabin 102. The interior of the internal cabin 102 is defined by sidewall panels that connect to a ceiling and a floor. The sidewall panels include lateral segments that connect to ceiling segments. The lateral segments define lateral wall portions, while the ceiling segments define at least portions of the ceiling within the internal cabin 102.

The internal cabin 102 includes multiple sections, including a front section 233, a first class section 234, a business class section 236, a front galley station 238, an expanded economy or coach section 240, a standard economy or coach section, and an aft section 244, which may include multiple lavatories, galley stations, and the lounge system 100. For example, the lounge system 100 can be installed in the aft section 244 behind the passenger seating area 103. In at least one example, the lounge system 100 spans across an entire width 105 of the internal cabin 102, and extends between a floor and ceiling of the internal cabin 102. As another example, the lounge system 100 can be disposed further into the passenger seating area 103, such as at location 100′. In this example, the lounge system 100 can include fore and aft doors that allow individuals to pass therethrough. It is to be understood that the internal cabin 102 may include more or less sections than shown. For example, the internal cabin 102 may not include a first class section, and may include more or less galley stations than shown.

As shown in FIG. 3A, the internal cabin 102 includes two aisles 250 and 252 that lead to the aft section 244. Optionally, the internal cabin 102 may have less or more aisles than shown. For example, the internal cabin 102 may include a single aisle that extends through the center of the internal cabin 102 that leads to the aft section 244.

Passenger seats 300 are positioned within the passenger seating area 103 within the internal cabin 102. The passenger seats 300 may be arranged in rows 301. In at least one example, the passenger seats 300 are not within the lounge system 100.

FIG. 3B illustrates a top plan view of an internal cabin 102 of an aircraft, according to an example of the present disclosure. The internal cabin 102 may be within a fuselage 281 of the aircraft. For example, one or more fuselage walls may define the interior of the internal cabin 102. The internal cabin 102 includes multiple sections, including a main cabin 282 having passenger seats 300, and an aft section 285 behind the main cabin 282. It is to be understood that the internal cabin 102 may include more or less sections than shown.

The internal cabin 102 may include a single aisle 284 that leads to the aft section 285. The single aisle 284 may extend through the center of the internal cabin 102 that leads to the aft section 285. For example, the single aisle 284 may be coaxially aligned with a central longitudinal plane of the internal cabin 280.

The lounge system 100 can be installed in the aft section 285 behind the passenger seating area 103. In at least one example, the lounge system 100 spans across an entire width 105 of the internal cabin 102, and extends between a floor and ceiling of the internal cabin 102. As another example, the lounge system 100 can be disposed further into the passenger seating area 103, such as at location 100′. In this example, the lounge system 100 can include fore and aft doors that allow individuals to pass therethrough.

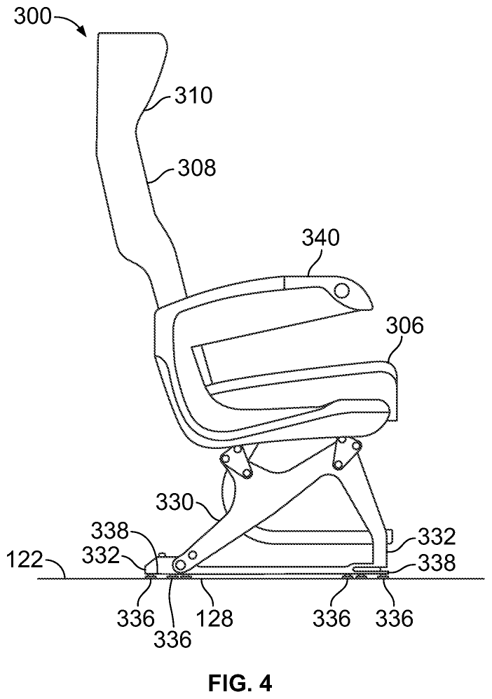

FIG. 4 illustrates a side view of a passenger seat 300, according to an example of the present disclosure. The passenger seat 300 is configured to be secured within an internal cabin of a vehicle, such as a commercial aircraft.

The passenger seat 300 includes a base 330, which may include legs 332 that may be secured to seat tracks 128 secured to a floor 122 within an internal cabin of an aircraft. In at least one example, securing studs 336 (such as shear studs) downwardly extend from lower surfaces 338 of the legs 332. The securing studs 336 are securely retained within the seat tracks 128. The seat tracks 128 are configured to securely couple to the securing studs 336 to secure the passenger seat 300 in place. The base 330 supports a seat cushion 306 and a backrest 308, which includes a headrest 310. Arm rests 340 may be pivotally secured to the backrest 308. Referring to FIGS. 1 and 4, the housing 106 of the lounge system 100 can also include securing studs 336 that are securely retained with the seat tracks 128.

The passenger seat 300 may be sized and shaped differently than shown in FIG. 4. The passenger seat 300 may include more or less components than shown in FIG. 4. It is to be understood that the passenger seat 300 shown in FIG. 4 is merely one example of a passenger seat that may be disposed within an internal cabin of a vehicle.

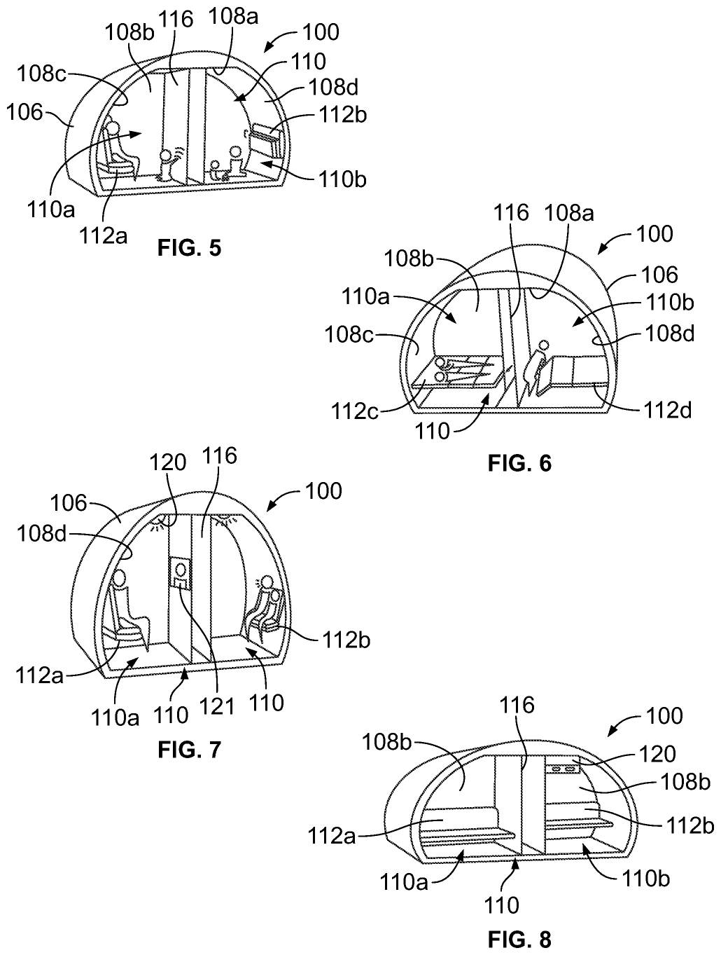

FIG. 5 illustrates a perspective front view of a lounge system 100, according to an example of the present disclosure. As shown, a partition wall 116 is in an extended position and extends between a ceiling wall 108a, a rear wall 108b, and a front end (or optionally front wall) of the housing 106, thereby forming a first sub-compartment 110a and a second sub-compartment 110b within the compartment 110. A passenger support 112a in the form of a bench is in the deployed position, and extends from a sidewall 108c within the first sub-compartment 110a. In contrast, a passenger support 112b in the form of a bench is in the stowed position, and folded against a sidewall 108d within the second sub-compartment 110b.

FIG. 6 illustrates a perspective front view of a lounge system 100, according to an example of the present disclosure. As shown, a partition wall 116 is in an extended position and extends between a ceiling wall 108a, a rear wall 108b, and a front end (or optionally front wall) of the housing 106, thereby forming a first sub-compartment 110a and a second sub-compartment 110b within the compartment 110. A passenger support 112a in the form of a bed is unfolded in the deployed position, and extends from a sidewall 108c within the first sub-compartment 110a. Similarly, a passenger support 112b in the form of a bed can be unfolded from a stowed position into a deployed position from the sidewall 108d within the second sub-compartment 110b.

FIG. 7 illustrates a perspective front view of a lounge system 100, according to an example of the present disclosure. As shown, an AV device 120 in the form of a projector can be mounted to a surface of one or both of a ceiling wall 108a and/or a sidewall 108d to project content 121 in the form of one or more graphics, text messages, images, videos, and/or the like onto a surface of the partition wall 116 in the extended position.

FIG. 8 illustrates a perspective front view of a lounge system 100, according to an example of the present disclosure. As shown, passenger supports 112a and 112b can extend from the rear wall 108b within the sub-compartments 110a and 110b. Further, an AV device 120 in the form of a television can be mounted to a wall, such as the rear wall 108b in one or both of the sub-compartment 110a and/or 110b.

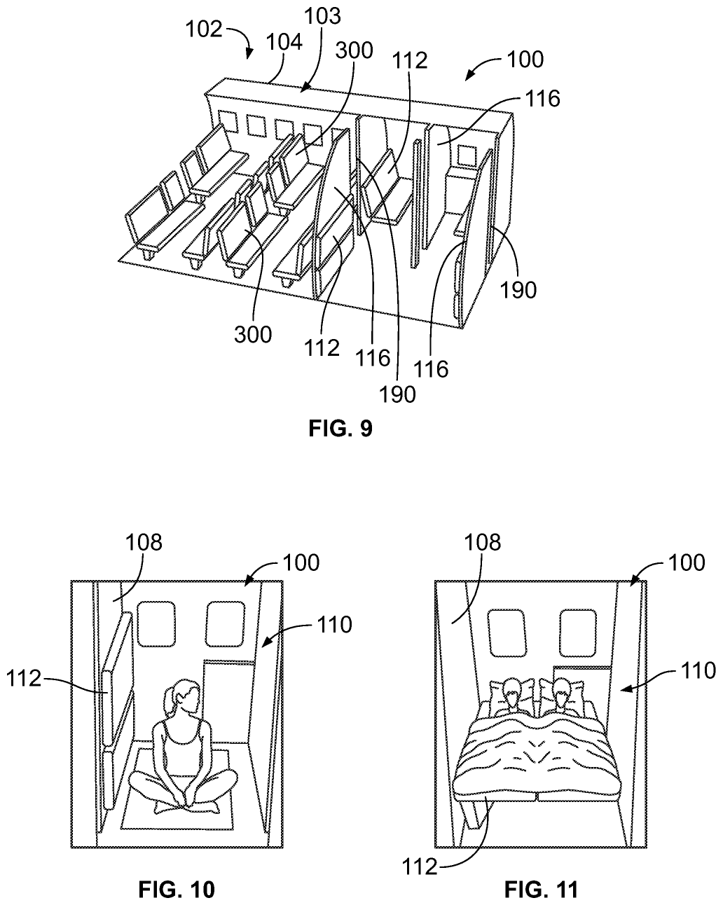

FIG. 9 illustrates a perspective internal view of an internal cabin 102 of an aircraft 104, according to an example of the present disclosure. As shown, the lounge system 100 is outside of the passenger seating area 103. The lounge system 100 can include passages 190 (which can include doors) that allow for passage into and through the lounge system 100.

FIG. 10 illustrates a perspective internal view of a lounge system 100, according to an example of the present disclosure. As shown, a passenger support 112 can be in a stowed position against a side wall 108, thereby providing an open space within the compartment 110, such as can be used for exercise.

FIG. 11 illustrates a perspective internal view of a lounge system 100, according to an example of the present disclosure. A passenger support 112, such as a foldable bed, can be extended from a wall 108 into a deployed position, to allow individuals to sleep thereon.

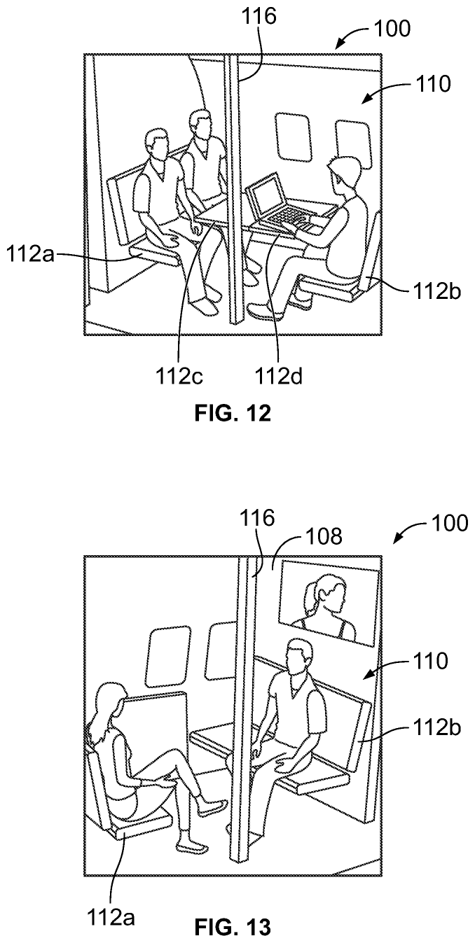

FIG. 12 illustrates a perspective internal view of a lounge system 100, according to an example of the present disclosure. Passenger supports 112c and 112d in the form of desks or trays can be unfolded from the partition 116 into deployed positions for use by individuals.

FIG. 13 illustrates a perspective internal view of a lounge system 100, according to an example of the present disclosure. Passenger supports 112a and 112b in the form of benches or seats can be unfolded from the walls 108 and/or partition 116.

Further, the disclosure comprises examples according to the following clauses:

Clause 1. A lounge system for an internal cabin of an aircraft, the lounge system comprising:
a housing including one or more walls defining an internal compartment; and
one or more passenger supports moveably coupled to the one or more walls, wherein the one or more passenger supports are movable between a stowed position and a deployed position.

Clause 2. The lounge system of Clause 1, further comprising one or more actuators operatively coupled to the one or more passenger supports, wherein the one or more actuators are configured to automatically move the one or more passenger supports between the stowed position and the deployed position.

Clause 3. The lounge system of Clauses 1 or 2, wherein the one or more passenger supports comprise one or more of a chair, a bench, a bed, a tray, or a desk.

Clause 4. The lounge system of any of Clauses 1-3, further comprising one or more partition walls moveably coupled to the one or more walls, wherein the one or more partition walls are moveable between an extended position that divides the internal compartment into sub-compartments, and a stowed position.

Clause 5. The lounge system of Clause 4, further comprising one or more audio-visual (AV) devices secured to one or both of the one or more walls or the one or more partition walls.

Clause 6. The lounge system of Clause 5, wherein the one or more AV devices comprise a projector configured to project content onto one or both of: (a) the one or more partition walls in the extended position, or (b) the one or more walls.

Clause 7. The lounge system of Clauses 5 or 6, wherein the one or more AV devices comprise a television mounted on the one or more walls.

Clause 8. The lounge system of any of Clauses 4-7, wherein the one or more passenger supports are also moveably coupled to the one or more partition walls.

Clause 9. The lounge system of any of Clauses 4-8, further comprising one or more actuators operatively coupled to the one or more partition walls, wherein the one or more actuators are configured to automatically move the one or more partition walls between the extended position and the stowed position.

Clause 10. The lounge system of any of Clauses 1-9, wherein the housing is configured to be removably secured within the internal cabin.

Clause 11. The lounge system of any of Clauses 1-10, wherein the housing is configured to be secured to one or more seat tracks of a floor within the internal cabin.

Clause 12. The lounge system of any of Clauses 1-11, wherein the housing is configured to be disposed outside of a passenger seating area of the internal cabin.

Clause 13. The lounge system of any of Clauses 1-12, wherein the housing is configured to be disposed within an aft area of the internal cabin.

Clause 14. An aircraft comprising:
an internal cabin; and
a lounge system within the internal cabin, the lounge system comprising:
   a housing including one or more walls defining an internal compartment; and
   one or more passenger supports moveably coupled to the one or more walls, wherein the one or more passenger supports are movable between a stowed position and a deployed position.

Clause 15. The aircraft of Clause 14, wherein the one or more passenger supports comprise one or more of a chair, a bench, a bed, a tray, or a desk.

Clause 16. The aircraft of Clauses 14 or 15, wherein the lounge system further comprises one or more partition walls moveably coupled to the one or more walls, wherein the one or more partition walls are moveable between an extended position that divides the internal compartment into sub-compartments, and a stowed position.

Clause 17. The aircraft of Clause 16, wherein the lounge system further comprises one or more audio-visual (AV) devices secured to one or both of the one or more walls or the one or more partition walls.

Clause 18. The aircraft of Clause 17, wherein the one or more AV devices comprise a projector configured to project content onto one or both of: (a) the one or more partition walls in the extended position, or (b) the one or more walls.

Clause 19. The aircraft of any of Clauses 16-18, wherein the one or more passenger supports are also moveably coupled to the one or more partition walls.

Clause 20. The aircraft of any of Clauses 14-19, wherein the housing is removably secured within the internal cabin.

Clause 21. The aircraft of any of Clauses 14-20, wherein the housing is secured to one or more seat tracks of a floor within the internal cabin.

Clause 22. The aircraft of any of Clauses 14-21, wherein the housing is disposed outside of a passenger seating area of the internal cabin.

Clause 23. The aircraft of any of Clauses 14-22, wherein the housing is disposed within an aft area of the internal cabin.

Clause 24. A method comprising:
disposing a lounge system with an internal cabin of an aircraft, the lounge system comprising:
   a housing including one or more walls defining an internal compartment;
   one or more passenger supports moveably coupled to the one or more walls, wherein the one or more passenger supports are movable between a stowed position and a deployed position;
   one or more partition walls moveably coupled to the one or more walls, wherein the one or more partition walls are moveable between an extended position that divides the internal compartment into sub-compartments, and a stowed position; and
   one or more audio-visual (AV) devices secured to one or both of the one or more walls or the one or more partition walls;
moving the one or more passenger support between the stowed position and the deployed position; and
moving the one more partition walls between the extended position and the stowed position.

As described herein, examples of the present disclosure provide areas within an internal cabin of an aircraft for individuals to relax, stretch their legs, have a moment of privacy, and the like. Further, examples of the present disclosure provide areas within an internal cabin of an aircraft where individuals can enjoy a calm, private setting away from a seating area.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

1. A lounge system for an internal cabin of an aircraft, the lounge system comprising:
a housing including one or more walls defining an internal compartment, wherein the housing is configured to be disposed outside of a passenger seating area of the internal cabin, wherein the housing is configured to span across an entire width of the internal cabin, and wherein the housing is configured to connect to a floor and a ceiling of the internal cabin; and
one or more passenger supports moveably coupled to the one or more walls, wherein the one or more passenger supports are movable between a stowed position and a deployed position.

2. The lounge system of claim 1, further comprising one or more actuators operatively coupled to the one or more passenger supports, wherein the one or more actuators are configured to automatically move the one or more passenger supports between the stowed position and the deployed position.

3. The lounge system of claim 1, wherein the one or more passenger supports comprise one or more of a chair, a bench, a bed, a tray, or a desk.

4. The lounge system of claim 1, further comprising one or more partition walls moveably coupled to the one or more walls, wherein the one or more partition walls are moveable between an extended position that divides the internal compartment into sub-compartments, and a stowed position.

5. The lounge system of claim 4, further comprising one or more audio-visual (AV) devices secured to one or both of the one or more walls or the one or more partition walls.

6. The lounge system of claim 5, wherein the one or more AV devices comprise a projector configured to project content onto one or both of: (a) the one or more partition walls in the extended position, or (b) the one or more walls.

7. The lounge system of claim 5, wherein the one or more AV devices comprise a television mounted on the one or more walls.

8. The lounge system of claim 4, wherein the one or more passenger supports are also moveably coupled to the one or more partition walls.

9. The lounge system of claim 4, further comprising one or more actuators operatively coupled to the one or more partition walls, wherein the one or more actuators are configured to automatically move the one or more partition walls between the extended position and the stowed position.

10. The lounge system of claim 1, wherein the housing is configured to be removably secured within the internal cabin.

11. The lounge system of claim 1, wherein the housing is configured to be secured to one or more seat tracks of a floor within the internal cabin.

12. (canceled)

13. The lounge system of claim 1, wherein the housing is configured to be disposed within an aft area of the internal cabin.

14. An aircraft comprising:
an internal cabin; and
a lounge system within the internal cabin, the lounge system comprising:
a housing including one or more walls defining an internal compartment, wherein the housing is disposed outside of a passenger seating area of the internal cabin, wherein the housing spans across an entire width of the internal cabin, and wherein the housing connects to a floor and a ceiling of the internal cabin; and
one or more passenger supports moveably coupled to the one or more walls, wherein the one or more passenger supports are movable between a stowed position and a deployed position.

15. The aircraft of claim 14, wherein the one or more passenger supports comprise one or more of a chair, a bench, a bed, a tray, or a desk.

16. The aircraft of claim 14, wherein the lounge system further comprises one or more partition walls moveably coupled to the one or more walls, wherein the one or more partition walls are moveable between an extended position that divides the internal compartment into sub-compartments, and a stowed position.

17. The aircraft of claim 16, wherein the lounge system further comprises one or more audio-visual (AV) devices secured to one or both of the one or more walls or the one or more partition walls.

18. The aircraft of claim 17, wherein the one or more AV devices comprise a projector configured to project content onto one or both of: (a) the one or more partition walls in the extended position, or (b) the one or more walls.

19. The aircraft of claim 16, wherein the one or more passenger supports are also moveably coupled to the one or more partition walls.

20. The aircraft of claim 14, wherein the housing is removably secured within the internal cabin.

21. The aircraft of claim 14, wherein the housing is secured to one or more seat tracks of a floor within the internal cabin.

22. (canceled)

23. The aircraft of claim 14, wherein the housing is disposed within an aft area of the internal cabin.

24. A method comprising:
disposing a lounge system with an internal cabin of an aircraft, the lounge system comprising:
a housing including one or more walls defining an internal compartment, wherein the housing is disposed outside of a passenger seating area of the internal cabin, wherein the housing spans across an entire width of the internal cabin, and wherein the housing connects to a floor and a ceiling of the internal cabin;
one or more passenger supports moveably coupled to the one or more walls, wherein the one or more passenger supports are movable between a stowed position and a deployed position;
one or more partition walls moveably coupled to the one or more walls, wherein the one or more partition walls are moveable between an extended position that divides the internal compartment into sub-compartments, and a stowed position; and
one or more audio-visual (AV) devices secured to one or both of the one or more walls or the one or more partition walls;
moving the one or more passenger support between the stowed position and the deployed position; and
moving the one more partition walls between the extended position and the stowed position.

25. The lounge system of claim 11, wherein the housing comprises securing studs configured to be securely retained within the seat tracks.

26. The aircraft of claim 21, wherein the housing comprises securing studs securely retained within the seat tracks.
